(19) United States
(12) Patent Application Publication
(10) Pub. No.: US 2010/0278192 A1
(43) Pub. Date: Nov. 4, 2010

(54) CHANNEL DATA MULTIPLEXING APPARATUS AND METHOD FOR SUPPORTING VARIABLE TRANSMISSION RATE

(75) Inventors: Keun-Pyo Hong, Daejon (KR); Hokyom Kim, Daejon (KR); Dae-Ig Chang, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejon (KR)

(21) Appl. No.: 12/808,110

(22) PCT Filed: Jun. 27, 2008
(86) PCT No.: PCT/KR08/03744

§ 371 Date: Jun. 14, 2010

(30) Foreign Application Priority Data
Dec. 14, 2007 (KR) 10-2007-0130714

(51) Int. Cl. H04J 3/00

(52) U.S. Cl. 370/468; 370/498

(57) ABSTRACT

Provided is a channel data multiplexing apparatus and method for supporting a variable transmission rate. The channel data multiplexing apparatus includes an input memory for receiving multi-channel baseband data in parallel and storing the baseband data at a first clock rate; an output memory for reading the baseband data stored in the input memory at a second clock rate and storing the baseband data; a multiplexing unit for reading the baseband data stored in the output memory in channel sequence at a third clock rate and outputting the baseband data in serial; and a control unit for controlling address processing and clock rates for data read/write (storage) from/in the input and the output memories and the multiplexing unit depending on a transmission mode.

### TECHNICAL FIELD

The present invention relates to a channel data multiplexing apparatus and method for supporting a variable transmission rate; and, more particularly, to a channel data multiplexing apparatus and method for supporting a variable transmission rate, which is capable of supporting various transmission rates of baseband data and simplifying the configuration of a demodulator arranged at a next stage, by temporal multiplexing of low rate multi-channel baseband data being received in parallel in a Multi-Frequency Time Division Multiple Access (MF-TDMA) system.

This work was supported by the Communications, Ocean and Meteorological Satellite program of MIC/IITA [2007-S-301, “Development of Satellite Communications System for Communications, Ocean and Meteorological Satellite”].

### BACKGROUND ART

In satellite communication systems, a satellite access method of return link adopts an MF-TDMA scheme.

This method modulates data using a plurality of carrier frequencies, and transmits it through a multiplicity of time slots, which mean that data transmission is made only for a given time, rather than all the time.

Typically, data can be loaded into one time slot with several carrier frequencies. By demodulating the data at a receiver end, baseband data are generated simultaneously at several carrier frequencies (channels).

In the prior art arrangement, in order to simultaneously demodulate the respective channel data simultaneously generated, a plurality of demodulators with the same functionality should be arranged in parallel to perform parallel processing, which is very inefficient in terms of system implementation.

In addition, since the prior art arrangement employs a demodulator capable of supporting a required transmission rate based on the transmission rate of baseband data being applied to the demodulator, it has a problem that cannot support an instance where the transmission rate of baseband data is variable depending on characteristics of services.

### DISCLOSURE OF INVENTION

### Technical Problem

It is, therefore, an object of the present invention to resolve the problems of the inefficiency in demodulator implementation and of not supporting various transmission rates.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

To accomplish the above-described objects, the present invention can convert low rate multi-channel baseband data being received in parallel into high rate serial data by temporal multiplexing and then transmit it to a demodulator in an MF-TDMA system.

In accordance with an aspect of the present invention, there is a channel data multiplexing apparatus for supporting a variable transmission rate, the apparatus including: an input memory for receiving multi-channel baseband data in parallel and storing the baseband data at a first clock rate; an output memory for reading the baseband data stored in the input memory at a second clock rate and storing the baseband data; a multiplexing unit for reading the baseband data stored in the output memory in channel sequence at a third clock rate and outputting the baseband data in serial; and a control unit for controlling address processing and clock rates for data read/write (storage) from/in the input and the output memories and the multiplexing unit depending on a transmission mode.

In accordance with another aspect of the present invention, there is a channel data multiplexing method for supporting a variable transmission rate, the method including: receiving multi-channel baseband data in parallel and storing the data in an input memory at a first clock rate; reading the multi-channel baseband data stored in the input memory at a second clock rate, and outputting baseband data of one channel to a demodulator and storing baseband data of the remaining channels in an output memory; and reading the baseband data stored in the output memory in channel sequence at a third clock rate, and performing temporal multiplexing on the baseband data and outputting the time-multiplexed baseband data in serial.

### ADVANTAGEOUS EFFECTS

In accordance with the present invention, low rate multi-channel baseband data that must be processed in parallel in an MF-TDMA based satellite communication system are converted into high rate serial data by temporal multiplexing for its output. Accordingly, the baseband data can be demodulated only by using a single high rate demodulator, without using plural demodulators configured in parallel by the channel number, thereby simply implementing a demodulation system arranged at a next stage at low costs.

Moreover, the present invention can convert multi-channel baseband data being received into high rate serial data regardless of its transmission mode, and thus, it can support various variable data transmission rates. As a result, the present invention can provide services suitable for various purposes in the MF-TDMA based satellite communication system.

### BRIEF DESCRIPTION OF THE DRAWINGS

FIG. 1 is a view describing a method for allocating channels by transmission modes in a satellite communication system to which the present invention is applied.

FIG. 2 is a block diagram illustrating the configuration of a channel data multiplexing apparatus for supporting a variable transmission rate in accordance with a preferred embodiment of the present invention.

FIG. 3 is a view describing a multiplexing method of baseband channel data of 4 channels being received in C transmission mode in accordance with another preferred embodiment of the present invention.

### BEST MODE FOR CARRYING OUT THE INVENTION

The advantages, features and aspects of the invention will become apparent from the following description of the embodiments with reference to the accompanying drawings, which is set forth hereinafter, and thus, the present invention will easily be carried out by those skilled in the art. Further, in the following description, well-known arts will not be described in detail if they could obscure the invention in unnecessary detail. Hereinafter, preferred embodiments of the present invention will be described in detail with reference to the accompanying drawings.

FIG. 1 is a view describing a method for allocating channels by transmission modes in a satellite communication system to which the present invention is applied.

An MF-TDMA based satellite communication system, to which the present invention is applied, has four kinds of data transmission modes and performs channel allocation, as shown in FIG. 1. In other words, the satellite communication system divides an allocated frequency spectrum 10 into several low rate channels for use therein.

When the conversion into baseband data is performed in order to demodulate return link at a central station, baseband data 11 for one channel, i.e., one channel data, baseband data 12 for two channels, i.e., two channel data, baseband data 13 for four channels, i.e., four channel data, and baseband data 14 for eight channels, i.e., eight channel data, are generated in A, B, C and D transmission modes, respectively.

In accordance with the present invention, since bypassing the channel data is enough in the fastest A transmission mode, a channel data multiplexing process is unnecessary. Further, the more the number of channels is increased, the more a data clock is divided.

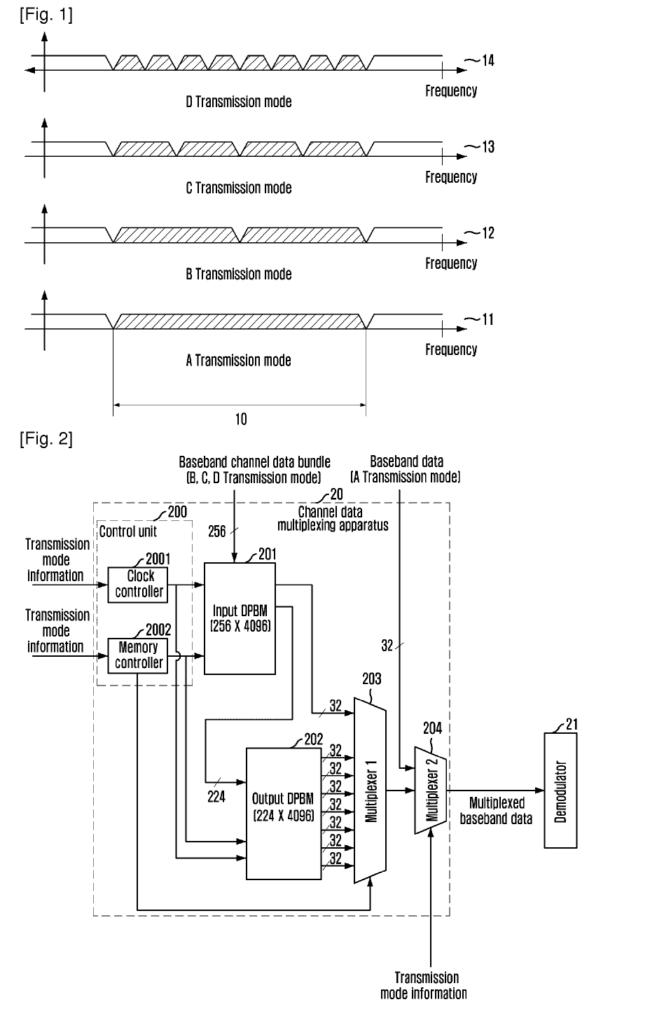

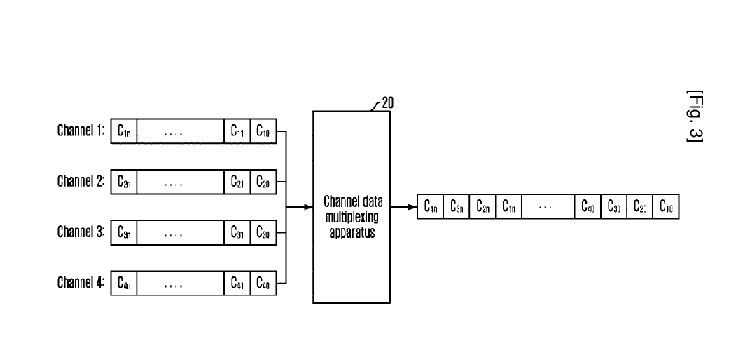

FIG. 2 is a block diagram illustrating the configuration of a channel data multiplexing apparatus for supporting a variable transmission rate in accordance with a preferred embodiment of the present invention. Hereinafter, a channel multiplexing method being executed in the channel data multiplexing apparatus will also be described together.

The inventive channel data multiplexing apparatus 20, as shown in FIG. 2, includes a control unit 200, an input Dual Port Block Memory (DPBM) 201, an output DPBM 202, and first and second multiplexors 203 and 204. Each of these components will be described in detail below.

First, the control unit 200 controls data read/write (storage) from/in the input DPBM 201 and the output DPBM 202, or address processing and clock rate for data output from the first multiplexor 203 depending on a transmission mode. As shown in the drawing, the control unit 200 is provided with a clock controller 2001 and a memory controller 2002.

More specifically, the clock controller 2001 controls a read/write clock rates of data from/in the input DPBM 201 and the output DPBM 202. The memory controller 2002 calculates a read/write address value, i.e., output/input address, of data from/in the input DPBM 201 and the output DPBM 202, which coincides with the length of time slot set in each transmission mode, and then provides the same to the corresponding memory. In addition, it controls selection and output of channel data from the first multiplexor 203.

Meanwhile, the input DPBM 210 takes low rate multi-channel baseband data in parallel and stores it under the control of the control unit 200. As shown in FIG. 2, it accepts in-phase/quadrature-phase baseband data outputted through an n-number of channels and functions to temporarily buffer the same.

That is to say, the input DPBM 201 stores baseband data of all channels for one time slot interval.

Here, the input/output data of the input DPBM 201 is formatted in symbol units, each of which is 256 bits, i.e., 16 bits×2 baseband×8 channels, capable of storing baseband data of 8 channels at its maximum. In addition, the number of data that can be stored maximally is designated by the number of longest time symbols. For example, the maximum number of symbols applied in FIG. 2 is 4096. Therefore, the size of the input DPBM 201 is 256*4096 bits. The data of 8 channels is not outputted until data corresponding to one time slot is all stored.

As a clock, i.e., first clock, for data write (storage) in the input DPBM 201, a clock suitable for each transmission mode is used. For instance, a 2-divided clock of the A transmission mode is used in the B transmission mode 12, a 4-divided clock of the A transmission mode is used in the C transmission mode 13, and an 8-divided clock of the A transmission mode is used in the D transmission mode 14.

Meanwhile, the output DPBM 202 serves to read data for an (n−1)-number of channels among the baseband data stored in the input DPBM 201 at a calculated time and temporarily store it under the control of the control unit 200. A clock for data reading from the input DPBM 201 to the output DPBM 202 is a data clock of the A transmission mode.

That is, the output DPBM 202 stores data corresponding to one time slot and then temporarily buffers the same for outputting it in channel sequence.

Here, the input/output data of the output DPBM 202 is 224 bits, i.e., 16 bits×2 basebands×7 channels, capable of storing baseband data of 7 channels. This is because the data of the first channel is not stored in the output DPBM 202 but applied directly to the first multiplexor 203 of the output end.

The number of data that can be stored at its maximum is designated by the number of longest time symbols, wherein the maximum number of symbols applied in FIG. 2 is 4094. Therefore, the size of the output DPBM 202 is 224*4096 bits.

As a clock, i.e., second clock, to write data in the output DPBM 202 and a clock, i.e., third clock, to read data from the output DPBM 202, a data clock for the fastest A transmission mode is used, regardless of the transmission mode.

On the other hand, the first multiplexor 203 of the output end reads the data stored in the output DPBM 202 in channel order in synchronism with the constant clock, i.e., third clock, under the control of the memory controller 2002, and delivers it to the demodulator 21 through the second multiplexor 204 after temporal multiplexing. As mentioned above, the third clock corresponds to the data clock of the A transmission mode.

Therefore, the multi-channel data in low rate transmission mode are converted in the form of parallel to serial in accordance with the data clock of the A transmission mode, and then provided to the demodulator 21.

Meanwhile, the second multiplexor 204 checks the transmission mode, and receives, if it is checked to be the A transmission mode with fastest transmission rate, the corresponding baseband data and immediately bypasses it to the demodulator 21.

As described above, in the present invention, since the number of symbols corresponding to the length of time slots should be stored in the memory by the channel number, efficient memory management is required. For example, if there are a large number of input/output data ports due to the use of an external memory only chip, its use is not proper. Accordingly, in a preferred embodiment of the present invention, a block RAM supported by Field Programmable Gate Array (FPGA) is used to effectively perform temporal multiplexing from low rate data generated through several channels to one high rate data.

FIG. 3 is a view describing a multiplexing method of baseband channel data of 4 channels being received in a C transmission mode in accordance with another embodiment of the present invention.

For example, when baseband data of 4 channels are inputted to the input DPBM 201 in parallel in the C transmission mode 13, they are time-multiplexed into high rate serial data, as shown in FIG. 3, and then applied to the demodulator 21 in serial. That is, the first multiplexor 203 reads baseband data of 4 channels in channel sequence and outputs it after temporal multiplexing.

The following is a detailed description for a channel data multiplexing process with reference to FIGS. 2 and 3.

In FIG. 3, first of all, baseband data C₁₀, C₂₀, C₃₀ and C₄₀ of 4 channels are stored in the input DPBM 201 in parallel for a first time slot interval. Thereafter, the baseband data C₁₀ of the first channel, i.e., channel 1, is outputted to the demodulator 21 via the first and the second multiplexors 203 and 204, and at the same time the baseband data C₂₀, C₃₀ and C₄₀ of the remaining channels, i.e., channels 2, 3 and 4, are stored in the output DPBM 202 in parallel. In other words, the baseband data C₁₀ of the first channel, i.e., channel 1, is outputted to the demodulator 21, and then, the baseband data C₂₀, C₃₀ and C₄₀ stored in the output DPBM 202 are outputted to the demodulator 21 in the sequence of channels 2, 3 and 4.

Meanwhile, when the baseband data C₁₀ stored in the input DPBM 201 is outputted to the demodulator 21 via the first and the second multiplexors 203 and 204, and the baseband data C₂₀, C₃₀ and C₄₀ are stored in the output DPBM 202, the input DPBM 201 is filled with the baseband data C₁₀, C₂₀, C₃₀ and C₄₀ being inputted in parallel for a next time slot interval.

The methods of the present invention may be programmed in a computer language. Codes and code segments constituting the computer program may be easily inferred by a computer programmer skilled in the art. Furthermore, the computer program may be stored in a computer-readable recording medium including all kinds of media such as CD-ROM, RAM, ROM, floppy disk, hard disk and magneto-optical disk, and read and executed by a computer to embody the methods.

The present application contains subject matter related to Korean Patent Application No. 2007-0130714, filed in the Korean Intellectual Property Office on Dec. 14, 2007, the entire contents of which are incorporated herein by reference.

While the present invention has been described with respect to the specific embodiments, it will be apparent to those skilled in the art that various changes and modifications may be made without departing from the spirit and scope of the invention as defined in the following claims.

1. A channel data multiplexing apparatus for supporting a variable transmission rate, the apparatus comprising:
an input memory for receiving multi-channel baseband data in parallel and storing the baseband data at a first clock rate;
an output memory for reading the baseband data stored in the input memory at a second clock rate and storing the baseband data;
a multiplexing unit for reading the baseband data stored in the output memory in channel sequence at a third clock rate and outputting the baseband data in serial; and
a control unit for controlling address processing and clock rates for data read/write (storage) from/in the input and the output memories and the multiplexing unit depending on a transmission mode.

2. The apparatus of claim 1, wherein the input memory stores multi-channel baseband data corresponding to one time slot set in the transmission mode in parallel.

3. The apparatus of claim 2, wherein the control unit controls that the multiplexing unit reads baseband data for a first channel among the baseband data stored in the input memory and outputs the read baseband data, and the output memory stores baseband data of the remaining channels in parallel.

4. The apparatus of claim 1, wherein the first clock rate is a data clock rate that coincides with a transmission mode of the received multi-channel baseband data.

5. The apparatus of claim 1, wherein each of the second and the third clock rates is a data clock rate that coincides with a transmission mode having a maximum transmission rate in a Multi-Frequency Time Division Multiple Access (MF-TDMA) communication system.

6. The apparatus of claim 1, wherein the multiplexing unit bypasses the baseband channel data being received in a transmission mode having a maximum transmission rate to a demodulator.

7. The apparatus of claim 1, wherein each of the input and the output memories is a Dual Port Block Memory (DPBM).

8. A channel data multiplexing method for supporting a variable transmission rate, the method comprising:
receiving multi-channel baseband data in parallel and storing the data in an input memory at a first clock rate;
reading the multi-channel baseband data stored in the input memory at a second clock rate, and outputting baseband data of one channel to a demodulator and storing baseband data of the remaining channels in an output memory; and
reading the baseband data stored in the output memory in channel sequence at a third clock rate, and performing temporal multiplexing on the baseband data and outputting the time-multiplexed baseband data in serial.

9. The method of claim 8, wherein the first clock rate is a data clock rate that coincides with a transmission mode of the received multi-channel baseband data.

10. The method of claim 8, wherein each of the second and the third clock rates is a data clock rate that coincides with a transmission mode having a maximum transmission rate in a Multi-Frequency Time Division Multiple Access (MF-TDMA) communication system.

11. The method of claim 8, wherein said receiving multi-channel baseband data stores multi-channel baseband data corresponding to one time slot set in the transmission mode in parallel.
